(19) United States
(12) Patent Application Publication
(10) Pub. No.: US 2008/0136217 A1
(43) Pub. Date: Jun. 12, 2008

(54) Heat-Insulating Underbody Structure

(76) Inventor: Hermann De Ciutiis, Winterthur (CH)

Correspondence Address: STURM & FIX LLP, 206 SIXTH AVENUE, SUITE 1213, DES MOINES, IA, 50309-4076, US

(21) Appl. No.: 11/576,720

(22) PCT Filed: Oct. 11, 2005
(86) PCT No.: PCT/CH05/00627

§ 371 Date: Dec. 27, 2007

(30) Foreign Application Priority Data
Oct. 11, 2004 (DE) 20 2004 015698.9

(51) Int. Cl. B62D 21/00

(52) U.S. Cl. 296/204

(57) ABSTRACT

A heat-insulating underbody structure comprises a heat shield (2) mounted on the vehicle underbody (1) at a distance. The space thereby defined is in principle open in order to generate a heat-insulating air layer between the heat shield and the vehicle underbody. The underbody structure is characterized in that it is provided with flow-impeding means (4, 5, 6, 7) which prevent the air from circulating between the heat shield (2) and the vehicle underbody (1).

The present invention concerns a heat-insulating underbody structure according to the preamble of claim 1, as well as a heat shield according to claim 9, suitable for use with said underbody.

Heat-shields, as are described for example in WO 00/22285, are well known in the field of modern vehicle technology and serve to insulate the vehicle underbody against heat generated by the individual vehicle components, in particular by exhaust pipes, catalyzers or mufflers. As these heat-shields are directly attached to the heat emitting components and therefore must be disassembled for repair work to these components and subsequently refitted, heat shields are also known which are attached to the vehicle underbody.

Thus, WO99/46147 describes a heat shield which does not need to be disassembled when replacing the above mentioned vehicle components. This heat shield abuts the underbody of a vehicle and is arranged in such a manner that it does not come into contact with the heat emitting vehicle components.

DE-U-9202228.6 describes a multi-part heat shield which is attached to the vehicle underbody by means of spacing brackets so as to create a heat insulating underbody construction. This heat insulating underbody construction comprises an air gap which is open in the front and rear and is situated between the heat shield and the underbody, so that the airstream can flow through freely between the heat shield and the vehicle underbody and thereby dissipate heat.

Unfortunately it has been shown in modern vehicles that the air heated by the engine and accompanying assemblies accumulates in the engine compartment and heats up further, due to the ever increasing improvements to engine compartment insulation means. It is not uncommon that this “self-heated” air reaches temperatures of up to 120° C. or higher. This self-heated air escapes from the open flooring and essentially streams through the space between heat shield and vehicle body when driving. It is understood that this fact leads to an undesirable increase in temperature in the underbody section and can even cause rapid aging or destruction of inner cladding materials or other sensitive components.

It is therefore the aim of the present invention to provide a heat insulating underbody structure with a heat shield which is spaced away from the vehicle underbody, the arrangement of said underbody structure ensuring that the temperatures in the gap between the heat shield and the vehicle underbody do not significantly exceed 80° C.

This aim is solved according to the invention by a heat insulating underbody structure having the features of claim 1, and in particular by an underbody structure in which the vehicle underbody is provided with a heat shield in the regions experiencing increased heat radiation, i.e. in the region of the exhaust pipe, the catalyzer or the muffler. The heat shield is spaced away from the underbody so as to form an open interspace, whereby the underbody structure comprises flow-impeding means which prevent self-heated external air, in particular hot air from the engine compartment, from circulating through the interspace. In particular, “self-heated external air” is the air which has been heated by the vehicle's own engine and its accompanying assemblies. At this point it should be explicitly mentioned that this interspace, in the following called an “open interspace”, is not a closed cavity but can allow air to flow through it, in particular so as to allow the hot air generated by the respective heat sources in the interspace to escape or to disperse.

In a first embodiment, the flow-impeding means partially comprise air-impervious interspace limiters which seal the interspace at least in the direction from which the air flows, i.e. upstream (windward). In particular a blade is suitable as a forward interspace limiter. It is understood that the interspace directly behind such a vane can have an opening from which the hot air generated in the interspace can escape. It is within the scope of the expert to design this vane in such a way that this (heated) air can be swept away by the outside airstream.

In a further embodiment, the airstream inhibiting means create an interspace limiter which is pervious to air, and this interspace limiter comprises, at least partially, a thermally stable fibrous material. Such fibrous material is well known to the expert and can comprise inorganic or organic fibers, in particular ceramic fibers.

In a preferred embodiment, the interspace is provided at least partially with a heat insulating material which is pervious to air.

In a further development of the present invention, means can be provided to link the interspace to cool surrounding air. In the following, “cool surrounding air” means the outside air which has not been heated by the vehicle itself.

In the following the invention shall be more closely described by means of an exemplary embodiment and with the aid of the Figures. These show:

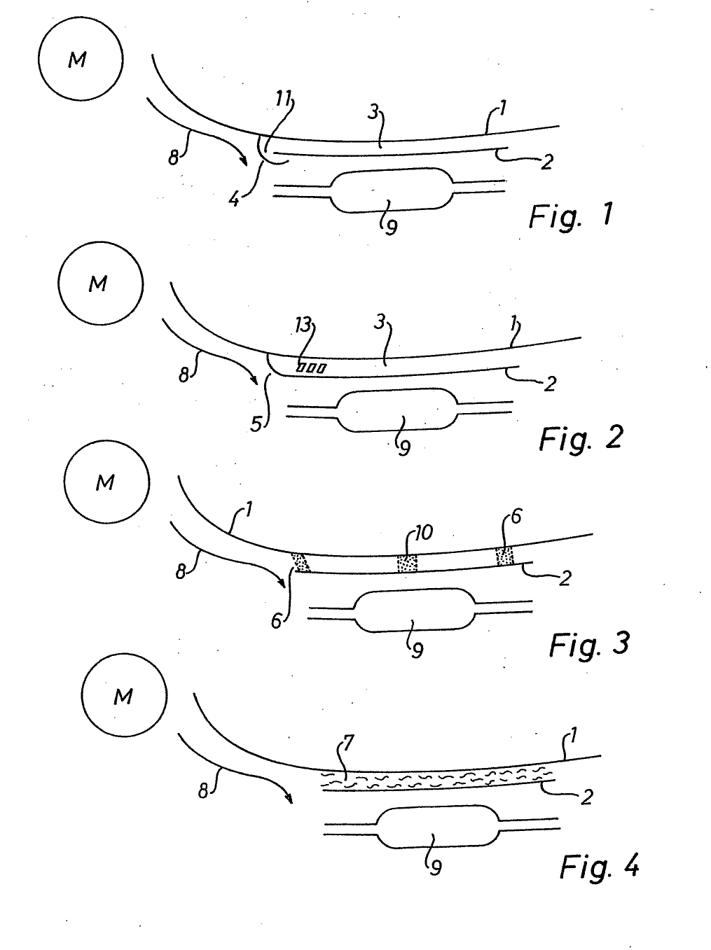

FIG. 1 a schematic view of the inventive underbody structure with a blade;

FIG. 2 a schematic view of the inventive underbody structure with an interspace sealed off upstream.

FIG. 3 a schematic view of the inventive underbody structure with an interspace limiter which is pervious to air.

FIG. 4 a schematic view of the inventive underbody structure with a heat insulation which is pervious to air.

FIG. 1 shows a schematic view of the construction and the working of the underbody construction according to the invention. This underbody construction has a vehicle underbody 1, to which a heat shield 2 is arranged at a distance in such a manner that an open interspace 3 is formed. This heat shield 2 lies in the region of the vehicle's own heat source 9, in particular in the region of an exhaust pipe, a catalyzer or similar. According to the invention the interspace 3 has flow-impeding means 4, 5, 6, 7 which prevent the self-heated external air which flows out of the engine compartment M from flowing though the interspace 3. In the embodiment shown in FIG. 1 the flow-impeding means have the shape of a blade 4. This blade 4 can either directly be part of the heat shield 2 or can be shaped as a separate component. In a specific embodiment of the invention, at least one opening (1 or more centimetres) are provided directly behind this blade 4, out of which the air heated in the open interspace 3 can exhaust and in particular can be swept away by the passing outside airstream 8.

FIG. 2 shows a further simple embodiment of the inventive underbody structure. This again comprises a vehicle underbody 1 to which a heat shield is attached in such a way that an interspace 3 is formed. This open interspace is sealed upstream by an air-impervious interspace limiter 5, in particular by a heat shield end piece. This prevents the upstream self-heated air 8 from the engine compartment M from entering the interspace 3. The air which has been heated by the heat source 9 in the interior of the interspace 3 can escape via a rearward opening 12 or via a lateral window 13.

In the embodiment of the inventive underbody structure shown in FIG. 3, the flow-impeding means are shaped as locally arranged, thermally stable fibrous material bolsters or pads 10. In this way, the air heated by the heat source 9 in the interspace 3 can escape out of this interspace 3 but the upstream self-heated external air from the engine compartment M is prevented from entering.

In a particular embodiment of the inventive underbody structure, the space between the heat shield 2 and the underbody 1 is provided with an air pervious heat insulation material 7. This heat insulation material 7 completely fills the interspace 3. It is understood that also in the above described embodiments, the interspace 3 can at least partially comprise air pervious heat insulation material 7.

The advantages of the inventive underbody structure are immediately apparent to the expert. In particular, the upstream self-heated external air 8 flowing from the engine compartment M is prevented from flowing into the interspace 3 between the heat shield 2 and the vehicle underbody 1.

Further embodiments and particular configurations of the inventive underbody structure are within the usual technical scope of the expert. Thus, depending upon the specific requirements and/or geometries, he will vary the distance between the heat shield 2 and the underbody by 5 to 20 mm, or will use a single- or multilayer heat shield 2. He can also design the blade 4 in a suitable way, in particular so that the air present in the interspace 3 is sucked out of that space. The expert will also adapt the choice of materials to the existing requirements.

1. Heat insulating underbody structure, in which a vehicle underbody (1) is provided at least partially with a heat shield (2), said heat shield being spaced from the underbody (1) so as to form an open interspace (3), wherein said underbody structure comprises flow-impeding means (4, 5, 6, 7) which impede self-heated external air (8), especially heated air from the engine compartment M, from flowing through the interspace (3).

2. Heat insulating underbody structure according to claim 1, wherein the flow-impeding means (4, 5, 6, 7) are partially designed as an air-impervious interspace limiter (5) which seals the interspace on its upstream side.

3. Heat insulating underbody structure according to claim 1, wherein the flow-impeding means (4, 5, 6, 7) are designed at least partially as an air-pervious interspace limiter (6).

4. Heat insulating underbody structure according to claim 2 or 3, wherein the flow-impeding means (4, 5, 6, 7) comprise a blade (4).

5. Heat insulating underbody structure according to claim 3, wherein the air-pervious interspace limiter (6) comprises thermally stable fibrous material.

6. Heat insulating underbody structure according to claim 1, wherein the interspace (3) is provided at least partially with air-pervious heat insulating material (7).

7. Heat insulating underbody structure according to claim 1, wherein the heat shield (2) is designed as a single- or multilayer heat shield.

8. Heat insulating underbody structure according to claim 1, wherein means are provided for linking the interspace (3) to cool surrounding air.

9. Heat shield (2) for use in a heat insulating underbody structure according to claim 1.
